(19) United States
(12) Patent Application Publication
(10) Pub. No.: US 2006/0249867 A1
(43) Pub. Date: Nov. 9, 2006

(54) Process for recycling formed EVA wastes

(76) Inventor: Joson Lin, Fengyuan City (TW)

Correspondence Address: HART, BAXLEY, DANIELS & HOLTON, 90 JOHN STREET, NEW YORK, NY, 10038, US

(21) Appl. No.: 10/441,747

(22) Filed: May 19, 2003

(51) Int. Cl. C08J 5/00

(52) U.S. Cl. 264/138; 264/331.18

(57) ABSTRACT

A process for recycling formed EVA wastes comprises the following steps: step 1: preparing the raw material of formed EVA wastes; step 2: heating the formed EVA wastes; step 3: rolling the formed EVA wastes; step 4: taking out the stripes of semi-final products. The details of the processes are: initially prepare the formed EVA wastes, and then heat them to the range from 80 to 200° C. (it would be the best if the temperature can be controlled within the range of 80-120° C.) so as to soften the formed EVA wastes. After this, putting the soft formed EVA wastes in rolling machines for repeated rolling so as to integrate them together, and finally the formed EVA wastes can be rolled into semi-final products in form of flat pieces, which can be applied to the carpet, mat or the shell of the traveling case (PE, ABS) and the likes.

### BACKGROUND OF THE INVENTION

1. Field of the Invention

The present invention relates to a process for recycling formed EVA wastes, and more particularly to a process by virtue of which the regenerated EVA will achieve the feature of better tensile strength, hardness and better bending-resistance after being processed.

2. Description of the Prior Arts

With the development of the industry, the demand on the formed EVA products is dramatically increased, and accordingly which resulted in a large quantity of formed EVA wastes. Thereby how to deal with these wastes is becoming a people's big headache. Conventional methods for dealing with the formed EVA wastes are very limited, either by deserting them directly or just by burning it out. In fact, which cannot be reclaimed at all. Thus, it will pollute the environment and uneconomical.

The present invention has arisen to mitigate and/or obviate the afore-described disadvantages of the conventional methods for dealing with the formed EVA wastes.

### SUMMARY OF THE INVENTION

The primary object of the present invention is to provide a process for recycling the formed EVA wastes, which is able to reclaim the formed EVA wastes so as to protect and clean the environment, and also it is economical.

The further object of the present invention is to provide a process for recycling the formed EVA wastes; by virtue of which the regenerated formed EVA will achieve the feature of better tensile strength, hardness and better bending-resistance after being processed.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a flow chart of showing the process for recycling formed EVA wastes in accordance with a first embodiment of the present invention;

FIG. 2 is a flow chart of showing the process for recycling formed EVA wastes in accordance with a second embodiment of the present invention.

### DETAILED DESCRIPTION OF THE PREFERRED EMBODIMENT

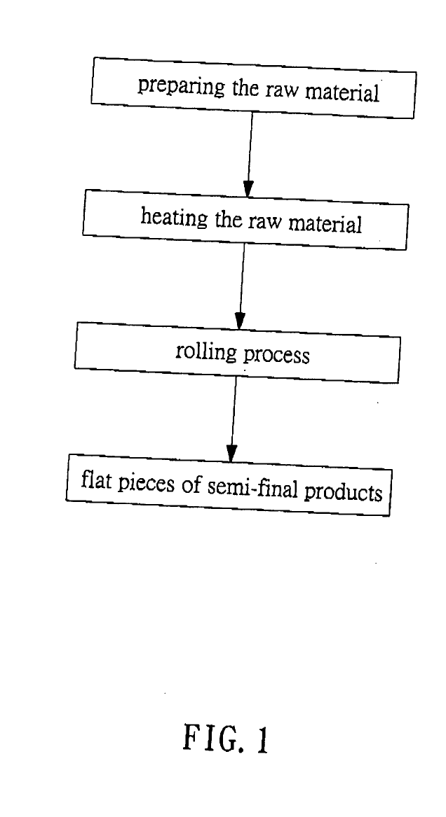

Referring to FIG. 1, which is a flow chart of showing the process is for recycling the formed EVA wastes in accordance with a first embodiment of the present invention and comprising the steps as follows: step 1: preparing the raw material of formed EVA wastes; step 2: heating the formed EVA wastes; step 3: rolling the formed EVA wastes; step 4: taking out the stripes of semi-final products. The details of the processes are: initially prepare the formed EVA wastes, and then heat them to the range from 80 to 200° C. (it would be the best if the temperature can be controlled within the range of 80-120° C.) so as to soften the formed EVA wastes. After this, putting the soft formed EVA wastes in rolling machines for repeated rolling so as to integrate them together, and finally the formed EVA wastes can be rolled into semi-final products in form of flat pieces, which can be applied to the carpet, mat or the shell of the traveling case (PE, ADS) and the likes. For example, in case of making the carpet, the semi-final products made from the formed EVA wastes can be preheated, and then is pressed for integrating with the carpet, and followed by cooling them down such that a product is formed which integrally formed by EVA wastes and carpet.

It will be noted that the semi-final products made from the formed EVA wastes is not only stable and unshrinkable but also after being hot rolled over and over again the same will have better tensile strength, hardness and better bending-resistance, which is accordingly. able to substitute for the PVC, PE, ABS, rubber and the likes.

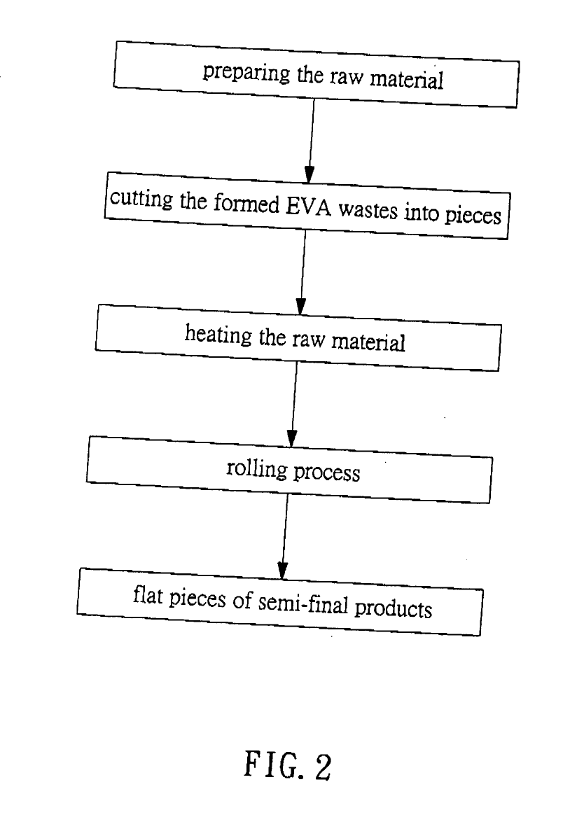

Referring now to FIG. 2, which is a flow chart of showing the process for recycling formed EVA wastes in accordance with a second embodiment of the present invention and comprising the steps as follows: step 1: preparing the raw material of formed EVA wastes; step 2: cutting the formed EVA wastes into pieces; step 3: heating the formed EVA wastes; step 4: rolling the formed EVA wastes; step 5: taking out the stripes of semi-final products. The best feature of which distinguishing from the process of the first embodiment of the present invention is: to cut the raw material of formed EVA wastes into small blocks or pellets before being processed, and then heat them to a high temperature range from 80 to 200° C. (the best temperature is controlled in the range of 80-120° C.) so as to soften the same. The followed procedures of the process are identical to that of the process of the first embodiment of the present invention. And alike, a flat piece of semi-final products can be formed by hot rolling.

While we have shown and described various embodiments in accordance with the present invention, it should be clear to those skilled in the art that further embodiments may be made without departing from the scope of the present invention.

What is claimed is:

1. A process for recycling formed EVA wastes comprising the following steps:
step 1: preparing the raw material: selecting all kinds of formed EVA wastes as raw materials;
step 2: heating the raw material: heating the formed EVA wastes to a temperature ranges from 80-200° C. so as to soften the same;
step 3: rolling process: putting the soft formed EVA wastes in the rolling machine for repeated rolling so as to integrate them together, such that flat pieces of semi-final products being formed and produced.

2. The process for recycling formed EVA wastes as claimed in claim 1, which further comprising a step of cutting the formed EVA wastes into small volumes after the preparing procedure for facilitating the heating and softening process.

3. The process for recycling formed EVA wastes as claimed in claim 1, wherein the heating temperature in the heating procedure should be best controlled in the range of 80-120° C.
